(19) United States
(12) Patent Application Publication
(10) Pub. No.: US 2017/0228680 A1
(43) Pub. Date: Aug. 10, 2017

(54) IMPROVEMENT MESSAGE BASED ON ELEMENT SCORE

(71) Applicant: HEWLETT PACKARD ENTERPRISE DEVELOPMENT LP, Houston, TX (US)

(72) Inventors: Einat Atedgi, Yehud (IL); Leo Reznik, Yehud (IL); Arik Sityon, Yehud (IL); Noa Danon, Yehud (IL)

(21) Appl. No.: 15/329,137

(22) PCT Filed: Aug. 29, 2014
(86) PCT No.: PCT/US14/53550

§ 371 Date: Jan. 25, 2017

(51) Int. Cl. G06Q 10/06

(52) U.S. Cl. CPC G06Q 10/06393

(57) ABSTRACT

In one implementation, a service management system can include a candidate engine to identify a plurality of elements of an ITSM process, a parameter engine to identify a plurality of parameters associated with the plurality of elements, a score engine to identify a score of a first element of the plurality of elements, and a suggestion engine to cause an improvement message to be generated based on the score and the plurality of elements.

### BACKGROUND

Information technology (“IT”) services are various and widely available. IT service providers involve organizing people, processes, and information technology. IT services can be supervised and maintained by implementation of IT service management (“ITSM”) principles and using ITSM applications.

### BRIEF DESCRIPTION OF THE DRAWINGS

FIGS. 1 and 2 are block diagrams depicting example service management systems consistent with disclosed examples.

FIG. 3 depicts an example environment in which various service management systems can be implemented consistent with disclosed examples.

FIG. 4 depicts example modules consistent with disclosed example service management systems,

FIGS. 5 and 6 are flow diagrams depicting example methods of improvement Identification consistent with disclosed examples.

### DETAILED DESCRIPTION

In the following description and figures, some example implementations of service management apparatus, systems, and/or methods of ITSM improvement identification are described, A service management process can be implemented to maintain a degree of qualify of a service. Incident management processes and change management processes are example IT service management processes. An incident management process is a process that defines how to handle incidents that disrupt a service. For example, procedures for handling an emergency incident can be different from procedures for handling minor incidents. A change management process is a process that defines how to handle changes to service, such as a software upgrade. For example, a change management process may restrict the rate at which infrastructure receive the upgrade and/or restrict times when an update can be performed by requiring a time approval to be requested and accepted by a manager. An ITSM application can assist in managing and collecting data regarding the quality of service of the IT service fulfillment. For example, to improve effectiveness, process bottlenecks can be identified and the people and IT can be managed and deployed in various ways to affect quality and effectiveness of the service solution. An IT provider can invest in time and energy, such as employing a consultant, to manually identify improvements for the IT service, such as ways to maintain quality of service.

Various examples described below relate to a framework for providing improvement suggestions based on a scoring framework using measures of collected data related to the IT service. By identifying parameters and scoring ITSM elements associated with the parameters, an element can be identified for improvement and a suggestion to modify the service process can be offered to establish the improvement.

The terms “include;” “have,” and variations thereof, as used herein, mean the same as the term “comprise” or appropriate variation thereof. Furthermore, the term “based on,” as used herein, means “based at least in part on.” Thus, a feature that is described as based on some stimulus can be based only on the stimulus or a combination of stimuli including the stimulus. Furthermore, the term “maintain” (and variations thereof) as used herein means “to create, delete, add, remove, access, update, manage, and/or modify.”

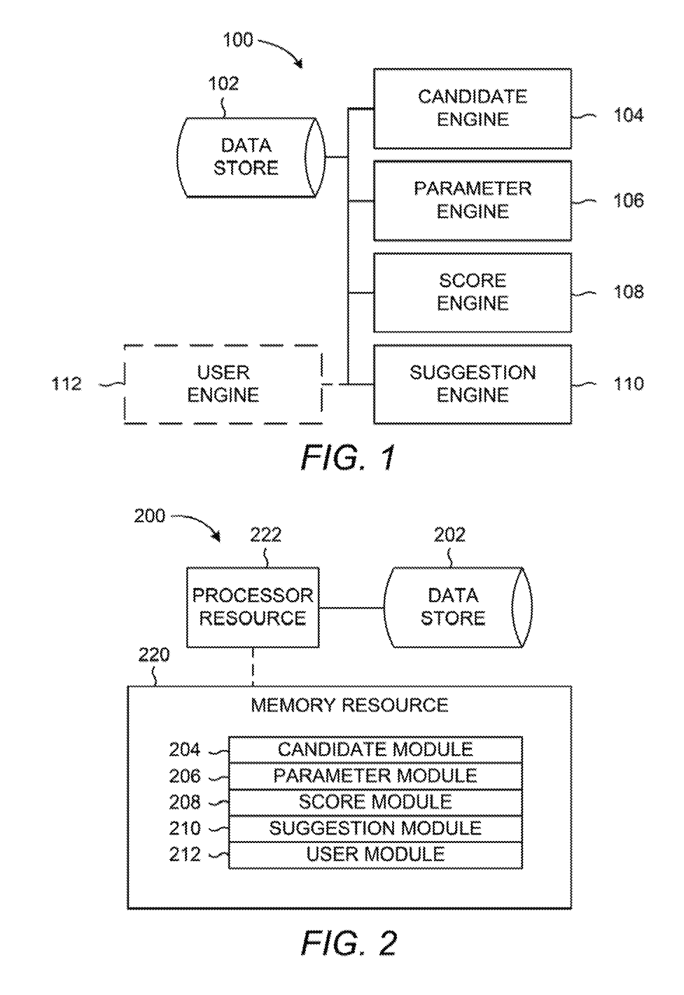

FIGS. 1 and 2 are block diagrams depicting example service management systems 100 and 200 consistent with disclosed examples. Referring to FIG. 1, the example service management system 100 of FIG. 1 generally includes a data store 102, a candidate engine 104, a parameter engine 106, a score engine 108, and a suggestion engine 110. In general, the suggestion engine 110 can provide an improvement based on evaluations of candidates identified by the candidate engine 104 using parameters of the parameter engine 106 as inputs to a score function to produce scores via the score engine 108. The example service management system 100 can include a user engine 112 to allow a user to customize the ITSM evaluation provided by the system 100.

The candidate engine 104 represents any circuitry or combination of circuitry and executable instructions to identify a plurality of elements of an ITSM process that affect a value of a performance indicator, such as a key performance indicator (“KPI”) value associated with the state or outcome of the IT service based on an ITSM metric. For example, a modification can be based on the ITSM metric when the modification would change the performance indicator value associated with the ITSM metric and the attribute of the candidate element that changes can be identified as a relevant parameter. A modification can be identified based on the ITSM metric, such as via a mapping of ITSM metrics to associated modifications based on a subject matter expert evaluation or a list of modification provided with each ITSM metric available for evaluation. An ITSM process represents a model of managing the IT service process, which may include multiple events at each phase of the process. An ITSM element represents a record (e.g. a ticket) or infrastructure (e.g. server or other device) of the service process. Example ITSM elements include a change record and an incident record. A record can have attributes, such as a property; for example, a change record can be a standard type or a normal type. For example, a standard change is a recurrent change that is structured to a relatively low risk process while a normal change is a relatively less structured change that follows the complete change management process. The plurality of elements can be elements that are candidates for improving the KPI by, for example, changing an attribute of the element or modifying the element model.

An ITSM metric represents a target mathematical function that can measure the effectiveness of processes of an organization. For example, a provider might want to define the success rate of changes in the organization as the target metric. Example metrics include a change success rate (i.e., a number of successful changed over the total number of changes), a change automation rate (i.e., a number of automated changes based on the total number of changes), and a change standardization rate (i.e., a number of standard changes based on the total number of changes). The ITSM metric can be evaluated based on a KPI. A KPI value represents a value dependent on an attribute of the service that is an important factor (e.g., importance can be designated by a user or by the system) or otherwise distinguishable factor to the performance of the service. An IT service provider can define a goal value for the KPI such value can be used in calculating a score relative to the elements of the service. The score function is discussed in more detail in the description associated with the score engine 108. The candidate engine 104 can calculate the KPI value over a time range. The time range can specify the amount of historical data to consider. The time range can be predetermined by the system 100, machine-learned, or provided as input from a user.

The ITSM element can be a record (e.g., a change record, incident record, etc.). Example modifications to a record can be one of a change to an attribute of the record, a switch from a first model class to a second model class, and an update to an automation status of an aspect of the first model class. For example, a switch between element models (e.g., from a model class of a normal type to a model class of a standard type) can improve the KPI and, in turn, improve the target metric. An attribute of the record can be a characteristic, a property, or other data associated with the record. For example, an attribute can be changed via a modification to a property or a quality of the record. An element model, such as a change model, is a template by which a record is created. An element model describes a procedure for handling a particular process event, such as a change to an IT service. A model class is a type or category of a model for a record. A provider can promote a certain change model to be a standard model and ease the way for future changes to the IT service and related ITSM modifications. Such a modification is modeled in an ITSM application by modifying an ITSM element such as changing a property or a status of the ITSM element to identify an improvement to the ITSM process. An aspect of the model, such as an event or task of the model, can be identified for automation. The automation status of an aspect can indicate whether the aspect is automated or manual. For example, an aspect can change from a manual process to an automated process when the ITSM process is updated with an automated script that was developed to complete the manual actions. A modification to the model to automate an aspect of the model can improve a target metric over maintaining the aspect as a manually operated aspect. Potential modifications can be kept in a list including, but not limited to, the above example modifications. The list can be organized or otherwise be designated which modifications are relevant to a metric, such as using a flag or other data structure.

The parameter engine 106 represents any circuitry or combination of circuitry and executable instructions to identify a plurality of parameters associated with the plurality of elements. For example, the parameter engine 106 can represent any circuitry or combination of circuitry and executable instructions to identify a plurality of parameters that assure a modification to the plurality of elements is suitable. Each of the plurality of parameters are a measurable attribute of the plurality of elements. The parameters are attributes of the ITSM elements that can assure with a particular probability that a modification is suitable by being safe, reasonable, and/or possible. For example, a high probability, such as a probability above a threshold that a modification is suitable, can establish that a modification can increase the KPI value. For another example, in standard rate KPI, if most of the changes based on a specific normal change model are successful and have low risk, the modification can be considered safe for the change model to become a standard change model. Such modification can increase the value of the standard rate KPI. Hence “success” and “risk” attributes of the changes are relevant parameters for the scoring function of standard rate KPI. Changes to attributes and other forms of modification can be predetermined as relevant, machine learned to be relevant, or provided as user-input to designate as a relevant parameter. For example, the metric can be mapped to parameters that affect the KPI value based on a knowledge base of known improvements. A parameter represents a measure of an ITSM element attribute. Example parameters include a process success rate and a process duration. Other examples of parameters include a parameter that is a direct indication of how much the candidate can improve the target KPI and a parameter (or multiple parameters) that identifies how feasible it is to perform a specific modification of the ITSM element. The plurality of parameters can be identified based on a possible modification. For example, a knowledge base of known modifications can contain a mapping from a modification to a plurality of parameters to use in a score function to evaluate the candidate ITSM elements.

The parameters can be a summary of historical data. Alternatively or in addition to, the parameter can be a function that takes historical data regarding the candidate as input. Each of the plurality of parameters can be a measureable attribute of the ITSM process. The parameter engine 106 can identify (e.g., select) the plurality of parameters based on past performance analysis and/or a status of an ITSM element. Past performance analysis can be obtained using a KPI monitoring system, which samples the ITSM elements at a certain frequency and saves a set of measures that describes the performance of the element to a database. Such metrics might include, for example, the success rate of tickets handled as part of an ITSM process or the duration of tickets in a process. The parameter engine 106 can aggregate over those measures to identify a parameter. Additional information can be used as well, such as the KPI goal value, to approximate mathematically how much a specific candidate can improve the target KPI based on the parameter or aggregation of parameters. The parameter engine 106 can analyze historical data based on a machine learning technique, such as a cluster technique, to identify a correlation among attributes of the plurality of elements and the KPI value. The parameter engine 106 can identify a parameter based on the correlation. A cluster technique can find a correlation between specific ITSM element attributes and a target KPI function. For example, a cluster technique can be used with historical data of the ITSM elements to find a correlation between a change model category to a success rate of the changes based on the change model and the correlation can be a relevant parameter for the score function to consider.

The parameter engine 106 can identify a degree of improvement to the KPI value and identify a degree of feasibility to implement a modification associated with an ITSM element. For example, parameters can be provided that identify the degree of feasibility based on the difference between a current ITSM process and a proposed ITSM process, such as a change from a normal model class to a standard model class. In order to estimate how feasible it is to implement a suggested modification, candidate attributes relevant to feasibility can be observed or retained from a knowledge base of known attribute effects. For example, if the target KPI is the level of automation in change model, the current level of automation in the ITSM elements is a parameter that can approximate feasibility (i.e., how easy it is) to deploy automation on each element. A modification may include multiple modifications and the number of changes can affect feasibility.

The score engine 108 represents any circuitry or combination of circuitry and executable instructions to identify a score of an element using a score function based on the plurality of parameters. A score represents the result of a score function relative to ITSM elements. The score function can be separate from the KPI function, and can receive KPI values as an argument. A score function represents a mathematical function that correlates data associated with the parameters into a value for comparison of the parameters and their effects on a performance indicator of the ITSM process. For example, a general score function can be defined as the sum of candidate specific values of a set of parameters, where the set of parameters are weighted based on the relevance of the parameters to the ITSM metric. For another example, a set of parameter values can be combined where each parameter can be a function that takes a candidate as input to the function that evaluates a particular set of historical data associated with candidate and produces a weighted value of the candidates rating of the parameter. The score engine 108 can define a score function based on the set of parameters identified by the parameter engine 106. For example, the score engine 108 can define the score function based on a first parameter identified as a degree of improvement to the KPI value and a second parameter identified as a degree of feasibility to implement a modification. The score function can produce a score that reflect the level of fitness of a candidate ITSM element based on the parameters relevant to the ITSM metric.

The score engine 108 can calculate a score based on a set of dimensions. The set of dimensions can act as a filter of for the results of the scoring. A set of dimension can include an ITSM element, an attribute of the ITSM element or ITSM process, and an attribute of the historical data. For example, a first improvement message can be removed from a plurality of improvement messages based on the ownership change record property. Dimension sets can be organized based on attributes of the ITSM elements and/or historical data. For example, a standardization dimension set can filter the score function to calculate only a specific subset of the data that matches the filter. In this manner, only a subset of the candidates are observed for improvement.

The suggestion engine 110 represents any circuitry or combination of circuitry and executable instructions to cause an improvement message to be generated based on the score and the plurality of elements. An improvement message represents a transmission having a payload to describe the ITSM element modification to improve a target metric. For example, an improvement message can be a suggestion to modify a change model to a standard type. The improvement message can be generated based on the ITSM metric to be evaluated, the score, the ITSM element associated with the score, and the modification. For example, the improvement message can be a template that states the ITSM metric can be improved by a percentage of the score difference by modifying the ITSM element based on an identified modification. The suggestion engine 110 can provide the improvement message to be generated. The improvement message can be provided, for example, by delivering the improvement message to a server-side interface or a client-side presentation mechanism. The improvement message can be provided in any consumable form, such as a presentation communication or a support communication. Example presentation communications include utilizing the message to present a web page or a message in the graphical user interface (“GUI”) of an application. Example support communications include a message transfer via an application programming interface (“API”) or a network transmission, such as a packet having the improvement message within the payload.

The user engine 112 represents any circuitry or combination of circuitry and executable instructions to receive arguments to define variables of the system 100. For example, the user engine 112 can receive data source arguments and score arguments. Example data source arguments include a time range and a set of dimensions. Example score arguments include a parameter class, a parameter weight, a target function, and a score function. A parameter class is a type of parameter to be used for score evaluation. A parameter weight is the amount of influence the parameter has on the outcome of the score function. A parameter weight can be based on an analysis by a subject matter expert or provided by a machine learning technique. For example, a plurality of parameter weights can be learned by the application using a machine learning technique that learns using a set of candidate elements and user feedback on the quality of the suggestions. The variables of the system 100 can be maintained based on user input via the user engine 112, a definition by the system 100, or a machine learning technique.

The data store 102 can contain information utilized by the engines 104, 106, 108, 110, and 112. For example, the data store 102 can store a candidate ITSM element, a parameter, a weight, a score function, a metric or target function, etc. For another example, the data store 102 can include a data source node having a knowledge base that includes suggestions and suggestion templates. A suggestion template represents a set of data useable by the suggestion engine 110 to produce an improvement message. For example, the suggestion template can comprise text and a section to insert the score and the KPI value to provide a user with information on how much improvement can be incurred based on the modification suggestion identified by the system 100 and provided in a message to the user.

FIG. 2 depicts an example service management system 200. System 200 comprises a memory resource 220 operatively coupled to a processor resource 222. The processor resource 222 can be operatively coupled to a data store 202. In some examples, the data store 202 can be the same as the data store 102 of FIG. 1.

Referring to FIG. 2, the memory resource 220 can contain a set of instructions that are executable by the processor resource 222. The set of instructions are operable to cause the processor resource 222 to perform operations of the system 200 when the set of instructions are executed by the processor resource 222. The set of instructions stored on the memory resource 220 can be represented as a candidate module 204, a parameter module 206, a score module 208, a suggestion module 210, and a user module 212. The candidate module 204, the parameter module 206, the score module 208, the suggestion module 210, and the user module 212 represent program instructions that when executed function in a manner similar to the candidate engine 104, the parameter engine 106, the score engine 108, the suggestion engine 110, and the user engine 112 of FIG. 1, respectively. The processor resource 222 can carry out the modules 204, 206, 208, 210, 212, and/or any other appropriate operations among and/or associated with the modules of the system 200. For example, the processor resource 222 can carry out the modules to identify a plurality of parameters to evaluate a modification to a first ITSM element against an ITSM metric (e.g., using historical analysis data and/or a current status of the ITSM element), evaluate a first score of a first ITSM element based on a scoring function comprising aggregated parameter and weights for the parameters, compare the first score with a second score of a second ITSM element, and cause an improvement message to be presented to a user when the first score indicates the KPI value is more improved by modifying the first ITSM element than modifying the second ITSM element. For another example, the processor resource 222 can carry out the modules to gather historical data based on a time range, identify a plurality of parameters (such as a parameter that directly increases the KPI value and a feasibility parameter), provide a plurality of weights based on a machine learning technique, and create a scoring function based on the plurality of parameters and weights to score candidate ITSM elements.

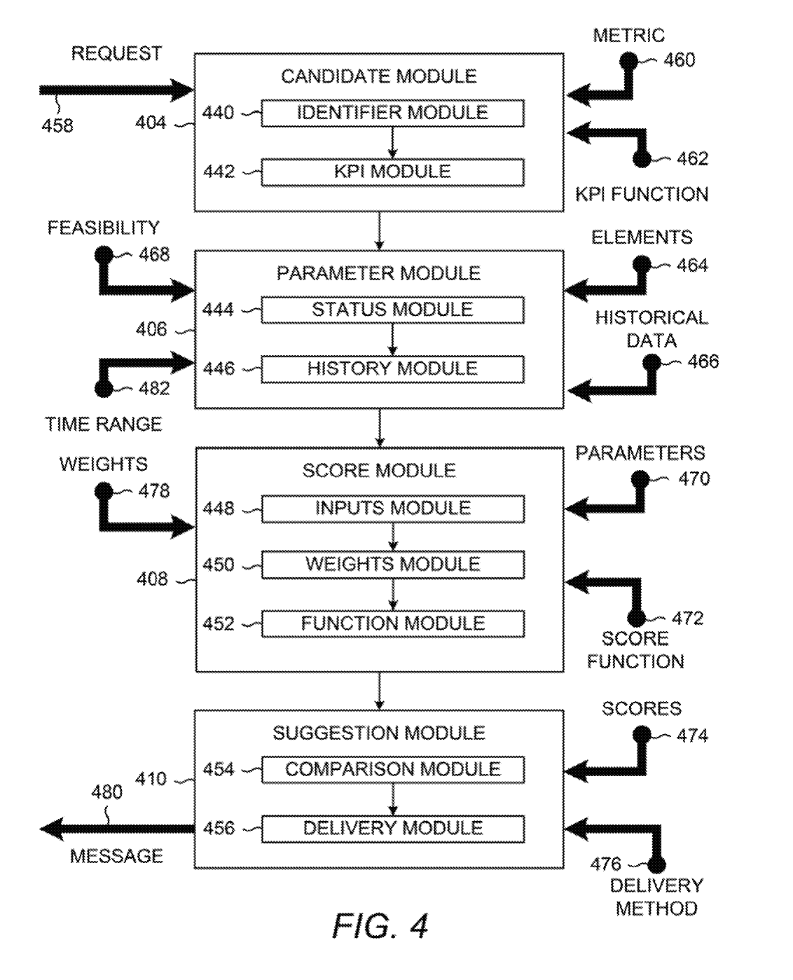

Although these particular modules and various other modules are illustrated and discussed in relation to FIG. 2 and other example implementations, other combinations or sub-combinations of modules can be included within other implementations. Said differently, although the modules illustrated in FIG. 2 and discussed in other example implementations perform specific functionalities in the examples discussed herein, these and other functionalities can be accomplished, implemented, or realized at different modules or at combinations of modules. For example, two or more modules illustrated and/or discussed as separate can be combined into a module that performs the functionalities discussed in relation to the two modules. As another example, functionalities performed at one module as discussed in relation to these examples can be performed at a different module or different modules. FIG. 4 depicts yet another example of how functionality can be organized into modules.

The processor resource 222 can be any appropriate circuitry capable of processing (e.g. computing) instructions, such as one or multiple processing elements capable of retrieving instructions form the memory resource 220, and executing those instructions. For example, the processor resource 222 can be at least one central processing unit (“CPU”) that enables ITSM service management by fetching, decoding, and executing modules 204, 206, 208, 210, and 212. Example processor resources 222 include at least one CPU, a semiconductor-based microprocessor, an application specific integrated circuit (“ASIC”), a field-programmable gate array (“FPGA”), and the like. The processor resource 222 can include multiple processing elements that are integrated in a single device or distributed across devices. The processor resource 222 can process the instructions serially, concurrently, or in partial concurrence.

The memory resource 220 and the data store 202 represent a medium to store data utilized and/or produced by the system 200. The medium can be any non-transitory medium or combination of non-transitory mediums able to electronically store data, such as modules of the system 200 and/or data used by the system 200. For example, the medium can be a storage medium, which is distinct from a transitory transmission medium, such as a signal. The medium can be machine-readable, such as computer- readable. The medium can be an electronic, magnetic, optical, or other physical storage device that is capable of containing (i.e. storing) executable instructions. The memory resource 220 can be said to store program instructions that when executed by the processor resource 222 cause the processor resource 222 to implement functionality of the system 200 of FIG. 2. The memory resource 220 can be integrated in the same device as the processor resource 222 or it can be separate but accessible to that device and the processor resource 222. The memory resource 220 can be distributed across devices. The memory resource 220 and the data store 202 can represent the same physical medium or separate physical mediums. The data of the data store 202 can include representations of data and/or information mentioned herein.

In the discussion herein, the engines 104, 106, 108, 10, and 112 of FIG. 1 and the modules 204, 206, 208, 210, and 212 of FIG. 2 have been described as circuitry or a combination of circuitry and executable instructions. Such components can be implemented in a number of fashions. Looking at FIG. 2, the executable instructions can be processor-executable instructions, such as program instructions, stored on the memory resource 220, which is a tangible, non-transitory computer- readable storage medium, and the circuitry can be electronic circuitry, such as processor resource 222, for executing those instructions. The instructions residing on the memory resource 220 can comprise any set of instructions to be executed directly (such as machine code) or indirectly (such as a script) by the processor resource 222.

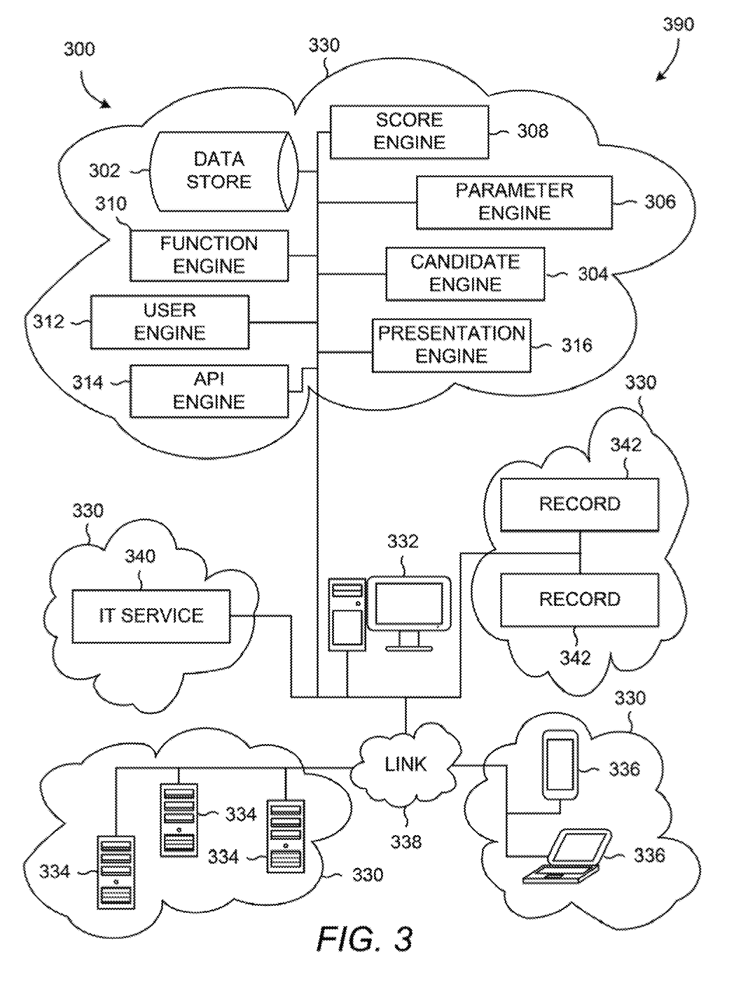

In some examples, the executable instructions can be part of an installation package that when installed can be executed by the processor resource 222 to implement the system 200. In such examples, the memory resource 220 can be a portable medium such as a compact disc, a digital video disc, a flash drive, or memory maintained by a computer device, such as a service device 334 of FIG. 3, from which the installation package can be downloaded and installed. In another example, the executable instructions can be part of an application or applications already installed. The memory resource 220 can be a non-volatile memory resource such as read only memory (“ROM”), a volatile memory resource such as random access memory (“RAM”), a storage device, or a combination thereof. Example forms of a memory resource 220 include static RAM (“SRAM”), dynamic RAM (“DRAM”), electrically erasable programmable ROM (“EEPROM”), flash memory, or the like. The memory resource 220 can include integrated memory such as a hard drive (“HD”), a solid state drive (“SSD”), or an optical drive.

FIG. 3 depicts an example environment 390 in which various example service management systems can be implemented consistent with disclosed examples. The example environment 390 is shown to include an example system 300 for managing a service. The system 300 (described herein with respect to FIGS. 1 and 2) can represent generally any circuitry or combination of circuitry and executable instructions to manage IT services. The system 300 can include a candidate engine 304, a parameter engine 306, a score engine 308, a suggestion engine 310, and a user engine 312 that are the same as the candidate engine 104, the parameter engine 106, the score engine 108, the suggestion engine 110, and the user engine 112 of FIG. 1, respectively, and the associated descriptions are not repeated for brevity. The system 300 can also include an API engine 314 and/or a presentation engine 316. The API engine 314 represents circuitry or a combination of circuitry and executable instructions to prepare the improvement message to be transmitted via an API. The presentation engine 316 represents circuitry or a combination of circuitry and executable instructions to prepare the improvement message to be transmitted to a presentation mechanism, such as preparing the message in a XML format or other web format. As shown in FIG. 3, the engines 304, 306, 308, 310, 312, 314, and 316 can be integrated into a compute device, such as a service device 334. The engines 304, 306, 308, 310, 312, 314, and 316 can be integrated via circuitry or as installed instructions into a memory resource of the compute device.

The example environment 390 can include compute devices, such as administrator devices 332, service devices 334, and user devices 336. A first set of instructions can be executed to perform functions of an ITSM application via an administrator device 332. For example, an application can be developed and modified on an administrator device 332 and stored onto a web server, such as a service device 334, for remote ITSM management. The service devices 334 represent generally any compute devices to respond to a network request received from a user device 336, whether virtual or real. For example, the service device 334 can operate a combination of circuitry and executable instructions to provide a network packet in response to a request for a page or functionality of an application. The user devices 336 represent generally any compute devices to communicate a network request and receive and/or process the corresponding responses. For example, a browser application may be installed on the user device 336 to receive the network packet from the service device 334 and utilize the payload of the packet to display an element of a page via the browser application. For another example, a user device 336 can request an IT service 340 and the request and/or operations of the IT service 340 can create ITSM elements, such as record 342.

The compute devices can be located on separate networks 330 or part of the same network 330. The example environment 390 can include any appropriate number of networks 330 and any number of the networks 330 can include a cloud compute environment. A cloud compute environment may include a virtual shared pool of compute resources. For example, networks 330 can be distributed networks comprising virtual computing resources. Any appropriate combination of the system 300 and compute devices can be a virtual instance of a resource of a virtual shared pool of resources. The engines and/or modules of the system 300 herein can reside and/or execute “on the cloud” (e.g. reside and/or execute on a virtual shared pool of resources).

A link 338 generally represents one or a combination of a cable, wireless connection, fiber optic connection, or remote connections via a telecommunications link, an infrared link, a radio frequency link, or any other connectors of systems that provide electronic communication. The link 338 can include, at least in part, intranet, the Internet, or a combination of both. The link 338 can also include intermediate proxies, routers, switches, load balancers, and the like.

Referring to FIGS. 1-3, the engines 104, 106, 108, 110, and 112 of FIG. 1 and/or the modules 204, 206, 208, 210, and 212 of FIG. 2 can be distributed across devices 332, 334, 336, or a combination thereof. Any device 332, 334, 336, or combination thereof may be part of the ITSM process and can be considered an ITSM element as well as the records 342. The engine and/or modules can complete or assist completion of operations performed in describing another engine and/or module. For example, the suggestion engine 310 of FIG. 3 can request, complete, or perform the methods or operations described with the suggestion engine 110 of FIG. 1 as well as the candidate engine 104, the parameter engine 106, and the score engine 108 of FIG. 1. Thus, although the various engines and modules are shown as separate engines in FIGS. 1 and 2, in other implementations, the functionality of multiple engines and/or modules may be implemented as a single engine and/or module or divided in a variety of engines and/or modules. In some examples, the engines of the system 300 can perform example methods described in connection with FIGS. 4-6.

FIG. 4 depicts example modules consistent with disclosed example service management systems. Referring to FIG. 4, the example modules of FIG. 4 generally include a candidate module 404, a parameter module 406, a score module 408, and a suggestion module 410. The example modules of FIG. 4 can be implemented on a compute device, such as a service device 334 of FIG. 3.

A request 458 can be received by a processor resource executing the candidate module 404. The candidate module 404 represents program instructions that when executed cause a processor resource to identify ITSM elements that are candidates for improvement (e.g., ITSM elements that are likely to improve a KPI value). The candidate module 404 can include program instructions, such as an identifier module 440 and a KPI module 442, to facilitate identification of candidate ITSM elements. The identifier module 440 can represent program instructions that when executed by a processor resource cause the elements of the ITSM process to be identified and selected as likely candidates based on the metric 460. The KPI module 442 can represent program instructions that when executed by a processor resource cause a KPI value associated with the metric 460 to be calculated by the processor resource based on a KPI function 462.

The parameter engine 406 represents program instructions that when executed cause a processor resource to identify parameters for use with a score function based on the elements 464 identified by the processor resource when executing the candidate engine 404. The parameter engine 406 can include program instructions, such as a status module 444 and a history module 446, to facilitate identification of parameters based the history and current status of each one of the elements 464. The status module 444 represents program instructions that when executed by a processor resource cause the current status of an ITSM element to be retrieved by the processor resource. The history module 446 represents program instruction that when executed by a processor resource cause the historical data 466 to be retrieved by the processor resource based on a time range 482. Additional information can be used for determining the parameters for the score function. Examples of additional information include a KPI value and information from a knowledge base, such as parameters that affect feasibility 468 as determined by a subject matter expert. For another example, a mapping of element attributes to score function parameters can be located in a data store. The parameter module 406 can be predefined with parameters associated with a target metric. For example, the parameter module 406, when executed by a processor resource, can cause a set of historical data to be retrieved by the processor resource based on a parameter mapped from the target metric. The parameters can be identified based on a probability that the elements can be suitably modified (e.g., safely and reasonably) to improve the performance indicator.

The score module 408 represents program instructions that when executed can cause a processor resource to provide a score for each candidate ITSM element. The score module 408 can include program instructions, such as an inputs module 448, a weights module 450, and function module 452, to cause a score value to be created by a processor resource based on parameters and data associated with a candidate ITSM element. The inputs module 448 represents program instructions that when executed by a processor resource cause the processor resource to identify the parameters used to score a candidate ITSM element. The weights module 448 represents program instructions that when executed by a processor resource cause a processor resource to associate a weight with a parameter. For example, a subject matter expert can identify a plurality of weights to set to a plurality of parameters based on historical data and predefine the weights as constants to produce a score that accurately represents the improvement possible by an element modification. The score module 408 can be provided with predetermined score functions 472 via known parameters 470 and weights 478 that represent the ITSM element. For example, the score module 408 can be predefined with score functions associated with target metrics, such as a first score metric to assess standardization of changes and a second score function to assess a change success rate. The score function 472 can be selected based on the target metric, such as via a mapping or other data structure mapping.

The suggestion module 410 represents program instructions that when executed cause a processor resource to provide a message 480 regarding an improvement based on a modification identified based on the scores produced via the score module 408. The suggestion module 410 can include program instructions, such as a comparison module 454 and a delivery module 456, that facilitate identifying a candidate element, identifying the improvement associated with the candidate element, and delivering the improvement to a source, such as a presentation source. The comparison module 454 represents program instructions that when executed by a processor resource cause a plurality of scores of the score module 408 to be compared by the processor resource. The suggestion module 410 can cause a processor resource to select a number of scores 474 based on the comparison by the processor resource when executing the comparison module 454. For example, a threshold may be used and the scores 474 associated with the threshold can be provided. A threshold can include a number of candidates (e.g., the top three candidates) or a score level to achieve (e.g. select candidates that can improve the ITSM process by at least 10%). The delivery module 456 represents program instructions that when executed by a processor resource cause a delivery method to be selected by the processor resource and cause the processor resource to prepare the improvement message 480 and deliver it based on the delivery method 476. For example, the improvement message 480 can be prepared to be provided by a presentation mechanism or to an application via an API call.

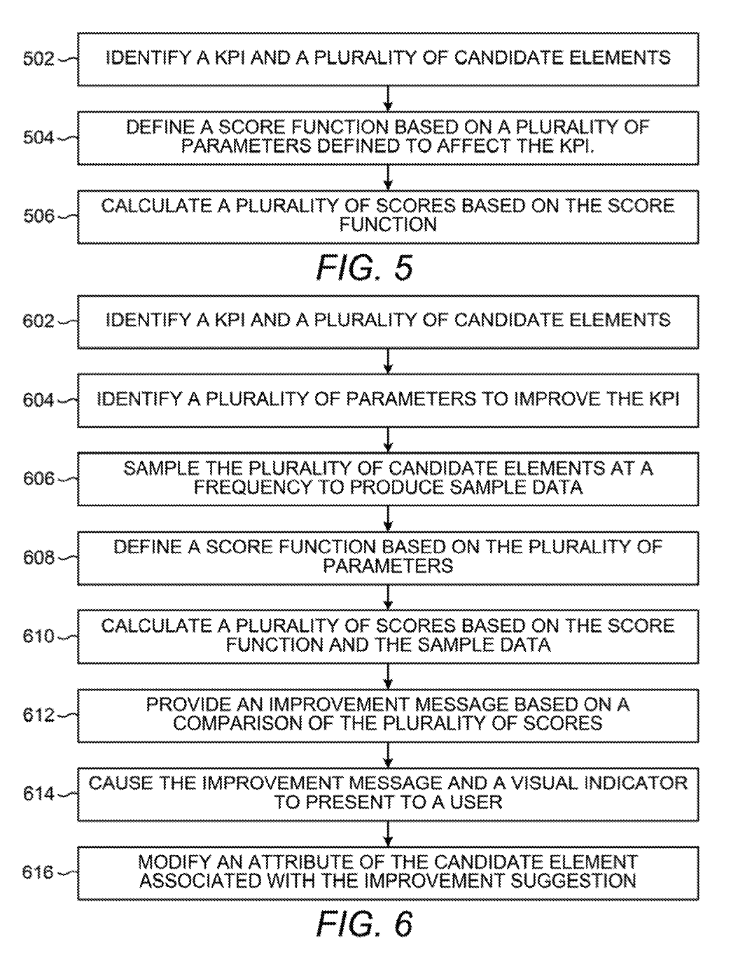

FIGS. 5 and 6 are flow diagrams depicting example methods of improvement identification consistent with disclosed examples. Referring to FIG. 5, example methods of improvement identification can generally comprise identifying a KPI value, defining a plurality of parameters to identify possible improvement to the KPI, defining a score function, identifying a plurality of candidate elements of an ITSM process, and calculating a plurality of scores based on the score function.

At block 502, a KPI and a plurality of candidate elements are identified. The KPI is identified based on the target metric to be improved. For example, the KPI can be a factor considered in achieving the target metric. The KPI value can be calculated based on a predetermined KPI function associated with a target metric and the plurality of candidate elements can be analyzed for attributes that affect the KPI value. The attributes can be used to identify a plurality of parameters. The plurality of parameters are to identify possible improvement to the KPI. For example, the plurality of elements of the ITSM process can be identified as candidates when the ITSM evaluation metric would be affected with a modification to each element, where the effect of the modification can be measured using the plurality of parameters and is suitable.

At block 504, a score function is defined based on a plurality of parameters. The parameters are selected based on the effect of parameters on the KPI. The score function can comprise a set of parameters based on data associated with a candidate element multiplied by a weight. For example, the score function can aggregate a set of weighted results associated with parameter functions to produce a value of a candidate ITSM element based on a set of data of a time range. The score function and/or data used by the score function can be defined based on user provided input. For example, a metric, a parameter, a weight, and a time range can be defined based on user-provided information. The score function can be based on parameters that achieve a threshold of probability that a modification is suitable.

At block 506, a plurality of scores are calculated based on the score function. The plurality of scores can be comparable. The plurality of scores can be associated with the plurality of candidate elements. In this manner, the scores can represent an improvement possibility of each candidate element. For example, the candidate element associated with the greatest score can provide the greatest improvement to the target function when performing the suggested modification to that candidate element. For another example, one of the plurality of scores can be selected when it is the highest score to achieve a predetermined threshold.

FIG. 6 includes blocks similar to blocks of FIG. 5 and provides additional blocks and details. In particular, FIG. 6 depicts additional blocks and details generally regarding sampling the plurality of candidate elements at a frequency, providing an improvement suggestion, causing an improvement message to present to a user, and modifying an attribute of the candidate element associated with the improvement suggestion. Blocks 602, 608, and 610 are the same as blocks 502, 504, and 506 of FIG. 5 and, for brevity, their respective descriptions are not been repeated.

At block 604, a plurality of parameters can be identified that affect the KPI value. An attribute of plurality of candidate elements can be identified as a parameter for the score function when the attribute is identified as relevant to an evaluation purpose of the ITSM evaluation metric. An attribute can directly affect the KPI or indirectly affect the KPI, such as the feasibility of an improvement based on a model modification suggested by the improvement message. A parameter can be identified based on the degree of affect (e.g., the degree of improvement) of the KPI and a probability that a modification is suitable.

At block 606, sample data can be produced by sampling the plurality of candidate elements at a frequency. The frequency can be a predetermined frequency set by the system, identified based on a machine learning technique, or provided as input from a user. The sample data can be saved and/or aggregated with a set of historical data that describes the performance of the candidate element during a time period based on the frequency.

At block 612, an improvement message can be provided based on a comparison of the plurality of scores. For example, an improvement message associated with the highest score can be selected for sending to a user. A score can be associated with a candidate element based on the parameters to produce the score. The candidate elements can be mapped to the improvement messages associated with the scores. The improvement message can be based on a suggestion template. For example, the suggestion template can be a text and graphic template having variables to be provided based on the score, the candidate element, and the KPI value and/or improvement to the IT service. The improvement message can be caused to present to a user at block 614, as well as a visual indicator of the possible improvement to the IT service. For example, a percentage of improvement can be provided by text coloration, highlighting, or a graph. The visual indicator can be associated with a degree of improvement of the KPI and/or IT service and can be caused to present to the user in a manner to convey the improvement to the KPI and/or IT service in a visual manner, such as a graphic.

The user can receive the message and initiate the suggestion provide. For example, the user can select to accept the suggestion via a GUI element. Based on user input, an attribute of the candidate element associated with the improvement suggestion can be modified at block 616. For example, a property of the candidate element or the status of the candidate element can be modified based on the improvement message and a user action associated with the improvement message. A user action represents an action for a user to take to implement the modification. The modification can result in an improvement to the IT service and a monitor of the service can verify the improvement based on historical data analysis.

Although the flow diagrams of FIGS. 4-6 illustrate specific orders of execution, the order of execution may differ from that which is illustrated. For example, the order of execution of the blocks may be scrambled relative to the order shown. Also, the blocks shown in succession may be executed concurrently or with partial concurrence. All such variations are within the scope of the present description.

The present description has been shown and described with reference to the foregoing examples. It is understood, however, that other forms, details, and examples may be made without departing from the spirit and scope of the following claims. The use of the words “first,” “second,” or related terms in the claims are not used to limit the claim elements to an order or location, but are merely used to distinguish separate claim elements.

What is claimed is:

1. A service management system comprising:
a candidate engine to identify a plurality of elements of an information technology service management (“ITSM”) process that affect a performance indicator value associated with an ITSM metric;
a parameter engine to identify a plurality of parameters that assure a modification to a plurality of elements, the modification based on the ITSM metric and each of the plurality of parameters to be a measurable attribute of the plurality of elements;
a score engine to identify a score of a first element of the plurality of elements using a score function based on the plurality of parameters; and
a suggestion engine to cause an improvement message to be generated based on the score and the plurality of elements.

2. The system of claim 1, wherein:
the candidate engine is to calculate the performance indicator value over a time range;
the parameter engine is to identify the plurality of parameters based on past performance analysis and a status of the first element; and
the score engine is to define the score function based on the plurality of parameters.

3. The system of claim 1, wherein the parameter engine is to:
identify a first parameter of the plurality of elements based in a degree of improvement to the performance indicator value; and
identify a second parameter of the plurality of elements based on a degree of feasibility to implement the modification associated with the first element.

4. The system of claim 3, wherein the parameter engine is to:
analyze historical data based on a machine learning technique to identify a correlation among attributes of the plurality of elements and the performance indicator value;
identify the first parameter based on the correlation; and
identify the degree of feasibility based on a difference between a current ITSM process and a proposed ITSM process.

5. The system of claim 1, further comprising:
a user engine to receive data source arguments and score arguments, the data source arguments to define at least one of a time range and a set of dimensions and the data source arguments to define at least one of a parameter class, a parameter weight, a target function, and the score function; and
a data source to store a suggestion template, the suggestion engine to produce an improvement message based on the suggestion template, the score, and the performance indicator value.

6. A non-transitory computer-readable storage medium comprising a set of instructions executable by a processor resource to:
identify a plurality of parameters to evaluate a modification to a first information technology service management (“ITSM”) element against an ITSM metric based on historical analysis data and a current status of the first ITSM element;
evaluate a first score of the first ITSM element based on a score function, the score function based on the plurality of parameters aggregated based on a plurality of weights associated with the plurality of parameters;
compare the first score to a second score of a second ITSM element; and
cause an improvement message to be presented to a user when the first score indicates a performance indicator value is more improved by modifying the first ITSM element than modifying the second ITSM element, the improvement message to identify the modification to the first ITSM element.

7. The medium of claim 6, wherein the set of instructions to identify the plurality of parameters is executable by the processor resource to:
identify a first parameter of the plurality of parameters based on a degree of directness of the first parameter to indicate an increase in the performance indicator value; and
identify a second parameter of the plurality of parameters based on a degree of feasibility to implement the modification on the first ITSM element.

8. The medium of claim 6, wherein the first ITSM element is a record and the modification is one of:
a change to an attribute of the record;
a switch from a first model type to a second model type; and
an update to an automation status of an aspect of the first model type.

9. The medium of claim 6, wherein the set of instructions is executable by the processor resource to:
gather historical data associated with the plurality of parameters based on a time range; and
provide the plurality of weights based on one of a subject matter expert analysis and a machine learning technique.

10. The medium of claim 6, wherein the first ITSM element is a change record and the ITSM metric is one of:
a change success rate to describe a number of success changes based on a number of total change;
a change automation rate to describe a number of automated changes based on the number of total change; and
a change standardization rate to describe a number of standard changes based on the number of total change.

11. A method of improvement identification comprising:
identifying a key performance indicator (“KPI”) to measure an information technology service management (“ITSM”) evaluation metric;
defining a plurality of parameters to identify possible improvement to the KPI based on an ITSM element modification;
defining a score function based on the plurality of parameters and a plurality of weights;
identifying a plurality of candidate elements of an ITSM process, that when modified, affect the ITSM evaluation metric;
calculating a plurality of scores associated with the plurality of candidate elements based on the score function; and
providing an improvement message based on a comparison among the plurality of scores, the improvement message to describe the ITSM element modification.

12. The method of claim 11, comprising:
identifying an attribute of the plurality of candidate elements that is relevant to an evaluation purpose of the ITSM evaluation metric;
identifying a degree of improvement of the KPI based on the ITSM element modification; and
identifying a degree of feasibility of the improvement based on the ITSM element modification suggested by the improvement message, the ITSM element modification to be a change to a model of the element.

13. The method of claim 11, comprising:
selecting a first score of the plurality of scores, the first score to achieve a predetermined threshold; and
selecting the improvement message associated with a first candidate element of the plurality of candidate elements that is associated with the first score of the plurality of scores.

14. The method of claim 11, comprising:
sampling a first candidate element of the plurality of candidate elements at a frequency identified by one of a predetermined time range and a user input; and
saving a set of historical data that describes a performance of the first candidate element during a time period based on the frequency.

15. The method of claim 11, comprising:
defining, based on user-provided information, one of the ITSM evaluation metric, the plurality of parameters, the plurality of weights, and a time range;
causing the improvement message to present to a user;
causing a visual indicator associated with a degree of improvement of the KPI to present to the user; and
modifying one of a property and a status of a first candidate element of the plurality of candidate elements based on the improvement message and a user action associated with the improvement message.
